(19) United States
(12) Patent Application Publication
(10) Pub. No.: US 2025/0092783 A1
(43) Pub. Date: Mar. 20, 2025

(54) METHOD AND SYSTEM FOR MINING RARE EARTH ORE BY DIRECT CURRENT

(71) Applicant: Guangzhou Institute of Geochemistry, Chinese Academy of Sciences, Guangzhou (CN)

(72) Inventors: Gaofeng Wang, Guangzhou (CN); Hongping He, Guangzhou (CN); Jianxi Zhu, Guangzhou (CN); Xiaoliang Liang, Guangzhou (CN); Wei Tan, Guangzhou (CN); Jie Xu, Guangzhou (CN); Jingming Wei, Guangzhou (CN); Shichang Kang, Guangzhou (CN); Yongqiang Yang, Guangzhou (CN); Yongjin Xu, Guangzhou (CN); Xiaoshan Zou, Guangzhou (CN)

(21) Appl. No.: 18/410,547

(22) Filed: Jan. 11, 2024

(30) Foreign Application Priority Data
Sep. 15, 2023 (CN) 202311194756.X

(51) Int. Cl. E21C 41/22; C22B 59/00

(52) U.S. Cl. CPC E21C 41/22; C22B 59/00

(57) ABSTRACT

The present disclosure provides a method and system for mining rare earth ore using a direct current. The system includes: liquid injection holes arranged in a mining area; electrodes arranged in the liquid injection holes; a leaching agent added into the liquid injection holes; and an electrification control system dividing the mining area into M equal parts and electrifying the electrodes using a cyclical alternate electrification method from 1 to M. In an Nu electrification cycle, all electrodes of an (M×n+N)ₜₕ row are connected to a positive electrode of a power supply, and all electrodes of an (M×n+N+1)ₜₕ row are connected to a negative electrode of the power supply. The cyclical alternate electrification method reduces at least (M−1)/M of power consumption, and the rare earth mining efficiency is improved.

### CROSS-REFERENCE TO RELATED APPLICATIONS

This application claims priority of Chinese Patent Application No. 202311194756. X, filed on Sep. 15, 2023, the entire contents of which are incorporated herein by reference.

### TECHNICAL FIELD

The present disclosure relates to the technical field of ionic rare earth mining, and in particular relates to a method and system for mining rare earth ore using a direct current.

### BACKGROUND

Ion-adsorbed rare earth, as a featured resource, provides 90% or more of medium and heavy rare earths worldwide. However, the existing in-situ leaching process of ammonium salt has the disadvantages of serious damage to ecological environment, long leaching cycle, low extraction rate of resources and being prone to landslide, severely restricting the mining and utilization of ion-adsorbed rare earth resources.

The patent with a publication number of CN109402417A provides an electric mining method, including the following steps: inserting an anode liquid injection pipe and a cathode liquid collection pipe into a rare ore body, an insertion position of the cathode liquid collection pipe being lower than that of the anode liquid injection pipe; and applying a direct current between the anode liquid injection pipe and the cathode liquid collection pipe to improve an extraction rate of rare earth and shorten the mining time.

However, an actual mine is large, and a plurality of sets of electrodes are required to be electrified simultaneously. There are serious problems in electrode arrangement and electrification solution, and high power consumption and high transformer power are required.

In addition, in the process of continuous electrification, excess electric charge is accumulated on the surface of the electrodes, hindering the electrified mining of rare earths.

On the other hand, as water is electrolyzed, H′ is generated at the anode to weaken the electroosmotic flow, and OH is generated at the cathode to precipitate rare earth ions, both of which reduce the efficiency of rare earth mining and pollute the soil.

More unfavorably, the continuous electrification reduces the time for the exchange of a leaching agent and rare earth ions, reducing the rare earth leaching rate.

### SUMMARY

An objective of the present disclosure is to solve the above defects in the prior art, and provide a method and system for mining rare earth ore using a direct current, aiming to solve the problems that the electrode polarization and acid and base produced by electrolysis are resulting from the continuous electrification, which reduces the efficiency of electrified mining, and requires high power demand and high energy consumption in the existing method for electrified mining of rare earth ore.

The present disclosure employs the following technical solutions.

A method for mining rare earth ore using a direct current includes the following steps:
step 1: arranging at least 3 rows and at least 1 column of liquid injection holes in a mining area, arranging electrodes in the liquid injection holes, and connecting each row of the electrodes in parallel to an electrification control system; and
step 2: adding a leaching agent to the liquid injection holes, and applying a direct current between the electrodes using the electrification control system based on a set electrification method,
the electrification method being cyclical alternate electrification, and
the cyclical alternate electrification referring to that the mining area is divided into M equal parts (M being a positive integer), and the electrification control system being used to carry out cyclical alternate electrification from 1 to M.

Preferably, M>2 (M being a positive integer), in an Nth (N≤M) electrification cycle, all electrodes of an (M×n+N)th (n=0, 1, 2, 3, . . . ) row are connected to a positive electrode of a power supply, and all electrodes of an (M×n+N+1)th (n=0, 1, 2, 3, . . . ) row are connected to a negative electrode of the power supply.

In one example of the present application, the number of cycles for the cyclical alternate electrification is at least greater than 2.

In one example of the present application, the number of rows of the liquid injection holes is determined by an area of the mining area, and spacing of the liquid injection holes of each row is 0.5-3 m.

Alternatively, the spacing of the liquid injection holes of each row is 1 m.

In one example of the present application, the number of columns of the liquid injection holes is determined by an area of the mining area, and spacing of the liquid injection holes of each column is 0.5-3 m.

Alternatively, the spacing of the liquid injection holes of each column is 1 m.

In one example of the present application, a depth of the liquid injection hole is determined by a thickness of a weathering crust.

Alternatively, the depth of the liquid injection hole is 5-50 m.

In one example of the present application, an arrangement depth of the electrode is determined by the depth of the liquid injection hole.

Alternatively, the arrangement depth of the electrode is 5-50 m.

Alternatively, the leaching agent includes at least one of ammonium sulfate, ammonium chloride, ammonium acetate, ammonium citrate, calcium chloride, magnesium sulphate, potassium sulfate, sodium sulfate, potassium chloride, and sodium chloride.

In one example of the present application, a voltage is applied between the positive electrode and the negative electrode to cause a voltage gradient in an ore body to be 10-200 V/m.

In one example of the present application, a duration of electrification lasts for 0.1-24 h per cycle.

A system for mining rare earth ore using a direct current includes:
liquid injection holes, at least 3 rows and at least 1 column of liquid injection holes being arranged in a mining area;
electrodes, the electrodes being arranged in the liquid injection holes, and each row of electrodes being connected in parallel to an electrification control system;
a leaching agent, the leaching agent being added into the liquid injection holes; and
the electrification control system, the electrification control system being configured to divide the mining area into M equal parts (M being a positive integer) and electrify the electrodes using a cyclical alternate electrification method from 1 to M.

Preferably, M>2 (M being a positive integer), in an Nth (N≤M) electrification cycle, all electrodes of an (M×n+N)ₜₕ (n=0, 1, 2, 3, . . . ) row are connected to a positive electrode of a power supply, and all electrodes of an (M×n+N+1)ₜₕ (n=0, 1, 2, 3, . . . ) row are connected to a negative electrode of the power supply.

The number of cycles for the cyclical alternate electrification is at least greater than 2.

The present disclosure has the following advantageous effects.

Compared with simultaneous electrification of all mining areas, the alternate electrification solution reduces the power demand in the mining process and reduces the construction cost of transformers, etc. In the process of cyclical alternate electrification, each row of electrodes is connected to the positive electrode and negative electrode of the power supply in turn, and an electrode switching phenomenon occurs. For example, in the electrification process of 3 equal parts of 3 cycles (M=3), in the 1ₛₜ (N=1) cycle, the 1ₛₜ row of electrodes is connected to the positive electrode, and the 2_{nd} row of electrodes is negatively electrified, . . . ; in the 2_{nd} cycle, the 2_{nd} row of electrodes is positively electrified, and the 3_{rd} row of electrodes is negatively electrified, . . . ; and in the 3_{rd} cycle, the 3_{rd} row of electrodes is positively electrified and the 4th row of electrodes is negatively electrified, The electrode switching phenomenon, on the one hand, is conducive to the elimination of polarization, reducing the accumulation of electric charge generated in the continuous electrification process and preventing the impact on the mining efficiency, and on the other hand, is capable of automatically neutralizing H′ and OH generated by electrolysis, preventing soil pollution. At the same time, in the process of cyclical alternate electrification, a leaching agent in an unelectrified area and rare earth ions in the soil can be fully exchanged, thus improving the rare earth leaching rate. Compared with the continuous electrification of all areas, the cyclical alternate electrification method not only reduces power consumption, but also increases the rare earth extraction rate.

### BRIEF DESCRIPTION OF THE DRAWINGS

FIG. 1 is a schematic diagram for a 3-cycle alternate electrification solution employed in Example 1;

FIG. 2 shows a power consumption comparison between Example 1 and Comparative Example 1;

FIG. 3 shows a comparison of a rare earth extraction rate between Example 1 and Comparative Example 1;

FIG. 4 shows a schematic diagram for a 4-cycle alternate electrification solution employed in Example 2;

FIG. 5 shows a power consumption comparison between Example 2 and Comparative Example 2;

FIG. 6 shows a comparison of a rare earth extraction rate between Example 2 and Comparative Example 2; and

FIG. 7 is a flow chart for the steps of the present disclosure.

### DETAILED DESCRIPTION

For clearer objectives, technical solutions and advantages of the present disclosure, the technical solutions of the present disclosure will be described clearly and completely below. Obviously, the examples described are only some, rather than all examples of the present disclosure. Based on the examples of the present disclosure, all other examples obtained by those ordinary skilled in the art without creative efforts are included in the scope of protection of the present disclosure.

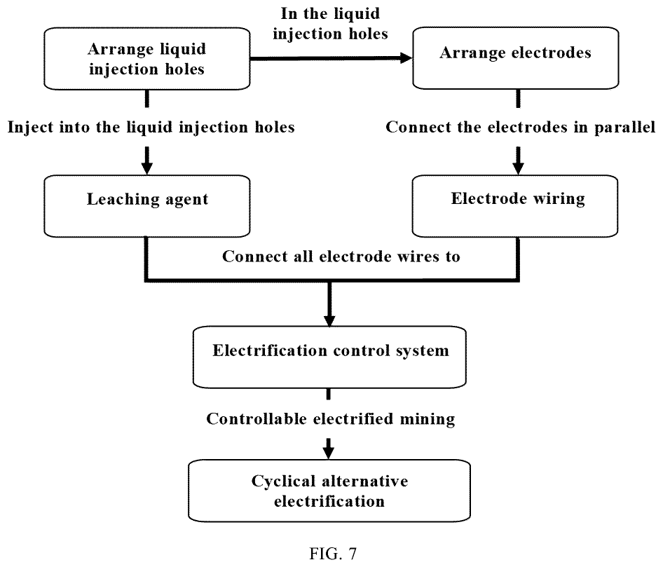

As shown in FIG. 7, a method for mining rare earth ore using a direct current includes the following steps.

At Step 1: at least 3 rows and at least 1 column of liquid injection holes are arranged in a mining area, electrodes are arranged in the liquid injection holes, and each row of the electrodes is connected to an electrification control system after being connected in parallel.

At Step 2: a leaching agent is added into the liquid injection holes, and a direct current is applied between the electrodes using the electrification control system based on a set electrification solution.

The electrification solution is cyclical alternate electrification.

The cyclical alternate electrification includes that an electrified mining area is divided into M equal parts, and the electrification control system is used to carry out cyclical alternate electrification from 1 to M.

Preferably, the electrified mining area is divided into M equal parts, M≥2, and the electrified mining area may be divided into 2, 3, 4, 5, . . . equal parts.

The electrification control system is used to perform cyclical alternate electrification from 1 to M, specifically, in an Nun (1≤N≤M) electrification cycle, all electrodes of an (M×n+N)ₜₕ (n=0, 1, 2 3, . . . ) row are connected to a positive electrode of a power supply, and all electrodes of an (M×n+N+1)ₜₕ (n=0, 1, 2, 3, . . . ) row are connected to a negative electrode of the power supply.

As an example, in the 2_{nd} cycle of 3-cycle alternate electrification (i.e., the 2_{nd} of 3 electrifications), the electrification control system will connect the 2_{nd}, 5ₜₕ, 8ₜₕ, 11ₜₕ, 14ₜₕ, . . . , and (3n+2)ₜₕ rows of electrodes to a positive electrode of a power supply, and the 3_{rd}, 6ₜₕ, 9ₜₕ, 12ₜₕ, 15ₜₕ, . . . , and (3n+2+1)ₜₕ rows of electrodes to a negative electrode of the power supply.

As another example, at the 3_{rd} cycle of 4-cycle alternate electrification (i.e., the 3_{rd} of 4 electrifications), the electrification control system will connect the 3_{rd}, 7ₜₕ, 11ₜₕ, 15ₜₕ, 19ₜₕ, . . . , and (4n+3)ₜₕ rows of electrodes to a positive electrode of a power supply, and the 4ₜₕ, 8ₜₕ, 12ₜₕ, 16ₜₕ, 20ₜₕ, . . . , and (4n+3+1)ₜₕ rows of electrodes to a negative electrode of the power supply.

At least 3 rows of liquid injection holes are arranged in the mining area, for example, the number of rows of liquid injection holes can be 3, 4, 5, 50, 1000, etc. The number of rows of liquid injection holes is determined by the area of the mining area, and the spacing of liquid injection holes of each row is from 0.5-3 m, for example, it can be 0.5 m, 1 m, 2 m or 3 m.

Note: the reason for at least 3 rows of liquid injection holes is that at least 2 cycles of alternate electrification are required, and 2 rows of liquid injection holes actually constitute only 1 cycle, so the alternate electrification cannot be performed.

At least 1 column of liquid injection holes is arranged in the mining area, for example, the number of columns of liquid injection holes may be 1, 4, 5, 50, 1000, etc. The number of columns of liquid injection holes is determined by an area of a mining area. Spacing of liquid injection holes of each column is 0.5-3 m, for example, it may be 0.5 m, 1 m, 2 m or 3 m. When there are a plurality of columns of liquid injection holes, the electrodes in at least 1 column of liquid injection holes may be connected in parallel. Specifically, 3 columns, 5 columns, 10 columns, or 50 columns may be connected in parallel. The number of columns to be connected in parallel is determined by a magnitude of the current that can be borne by a parallel cable.

The electrodes are arranged in the liquid injection holes.

The method of the present disclosure does not limit the positive electrode and the negative electrode of the electrodes in each liquid injection hole. When the electrification control system realizes free switching between the positive electrode and the negative electrode, the electrode in the same liquid injection hole changes from being used as a positive electrode of the power supply to being used as a negative electrode of the power supply, or from being used as a negative electrode of the power supply to being used as a positive electrode of the power supply, reducing the number of sub-power supplies required by the electrification control system. For example, in an original electrification process, 9 separate power supplies are required by 10 rows of liquid injection holes to realize the electrification control of the 1ₛₜ and 2_{nd}, the 2_{nd} and 3_{rd}, the 3_{rd} and 4ₜₕ, . . . the 9ₜₕ and 10ₜₕ rows, while in this electrification control system, only 5 sub-power supplies are required to provide 10 rows of wiring due to the switching between the positive electrode and the negative electrode.

In an actual mining process, due to the large size of a mine, it is necessary to electrify multiple sets of electrodes at the same time. The electrodes in the liquid injection holes in a traditional electrified mining process are fixedly connected to a positive electrode or a negative electrode of the power supply, and excess electric charge will be accumulated on the surface of the electrodes in the process of continuous electrification, hindering the electrified mining of rare earths. On the other hand, due to water electrolysis, H′ is generated at the anode to weaken the electroosmotic flow, and OH is generated at the cathode to precipitate rare earth ions, both of which reduce the efficiency of rare earth mining and pollute the soil. More unfavorably, the continuous electrification reduces the time for the exchange of leaching agent and rare earth ions, reducing the rare earth leaching rate.

The number of cycles for cyclical alternate electrification is at least greater than 2, for example, it may be 2-cycle alternate electrification, 3-cycle alternate electrification, or 4-cycle alternate electrification. Correspondingly, the 2-cycle alternate electrification, the 3-cycle alternate electrification, and the 4-cycle alternate electrification divide the electrified mining area into 2 equal parts, 3 equal parts, and 4 equal parts, respectively.

Compared with simultaneous electrification of all mining areas, the cyclical alternate electrification solution divides the electric mining into 2 equal parts, 3 equal parts, 4 equal parts, . . . , and each cycle of electrification process reduces the electric power demand of electric mining and the construction cost of transformer, the complexity of electrode arrangement (which is required to find out the anode electrode location and cathode electrode location based on the actual survey, but now there is no need for such a design) and the length of wire and cable (in the original electrodes, the anode is distributed at the top of the mine, while the cathode is distributed at the middle part the mine, and now all of them can be distributed at the top of the mine, and the length of the wire and cable can be reduced). At the same time, in the process of cyclical alternate electrification, the leaching agent in the unelectrified area and rare earth ions in the soil can be fully exchanged, thus improving the rare earth leaching rate.

The division of the electrified area per cycle and the connection of positive and negative electrodes to the electrode are shown according to the formula of the present disclosure:
in an Nₜₕ (1<N<M) electrification cycle, all the electrodes of the (M×n+N)ₜₕ (n=0, 1, 2, 3, . . . ) row are connected to the positive electrode of the power supply, and all the electrodes of the (M×n+N+1)ₜₕ (n=0, 1, 2, 3, . . . ) row are connected to the negative electrode of the power supply.

In the electrification solution, each row of electrodes is connected to the positive electrode and the negative electrode of the power supply in turn, and the electrode switching phenomenon occurs, which on the one hand is conducive to eliminating polarization, reducing the accumulation of electric charge generated by a continuous electrification process, and preventing the influence of the efficiency of electrified mining, and on the other hand, is capable of automatically neutralizing H′ and OH generated by electrolysis, preventing soil pollution. It is worth noting that the electrode reversal of the electrification solution of the present disclosure is not an electrode swap between two sets of fixed electrodes traditionally, but a cross-power supply electrode reversal, that is, a negative electrode of the last set of power supply becomes a positive electrode, a positive electrode of the next set of power supply becomes a negative electrode, and a new set of power supply is re-formed between the last set of power supply and the next set of power supply.

According to the electrification solution of the present disclosure, the rare earth ions in any cycle always migrate towards the same direction without reversal of current direction and reverse migration of rare earth ions. If the positive electrode and the negative electrode are swapped between two electrodes of a fixed power supply during pulse electrification, the electrode polarization can be effectively relieved, but some ions diffuse backwards within the reverse electrification time, reducing the rare earth migration efficiency.

At the same time, compared with the continuous electrification of all areas, not only is the rare earth mining efficiency improved, but ⅔ of the power consumption is reduced in the example of the 3-cycle alternate electrification solution, and ¾ of the power consumption is reduced in the example of the 4-cycle alternate electrification solution.

The depth of the liquid injection hole is determined by the thickness of the weathering crust, which ranges from the surface to above the semi-weathered layer, and may be 5 m, 10 m, 20 m or 30 m.

The arrangement depth of the electrode of the present disclosure is determined by the depth of the liquid injection hole, a depth range of which is a range of an ore-rich layer within the liquid injection hole and can be 5 m, 10 m, 20 m or 30 m.

The leaching agent used in the method of the present disclosure includes ammonium salt, calcium salt, magnesium salt, sodium salt or potassium salt. Further, the leaching agent in the example includes at least one of ammonium sulfate, ammonium chloride, ammonium acetate, ammonium citrate, calcium chloride, magnesium sulphate, potassium sulfate, sodium sulfate, potassium chloride, and sodium chloride.

A voltage is applied between two electrodes, and the rare earth ions in the soil undergo directional migration under the action of the electric field. Based on experimental results, a voltage gradient of 10-200 V/m in the ore body is favorable for the flow of rare earth ions towards the cathode. The voltage gradient in the ore body may be 10 V/m, 20 V/m, 50 V/m, 60 V/m, 100 V/m, 150 V/m or 200 V/m, etc.

As described above, a duration for the cyclical alternate electrification lasts for 0.1-24 h per cycle, for example, it can be 0.1 h, 1 h, 2 h, 4 h, 8 h, 12 h, 16 h, 20 h, and 24 h. The pHs of anode and cathode can be monitored in the electrification process. When the pH of the cathode is alkaline and the rare earth ions begin to precipitate, the next cycle of electrification can be switched to.

The present application also provides a system for mining rare earth ore using a direct current, including:
at least 3 rows and at least 1 column of liquid injection holes arranged in a mining area, electrodes arranged in the liquid injection holes, and an electrification control system connected to each row of the electrodes connected in parallel; and
a leaching agent added into the liquid injection holes, a direct current being applied between the electrodes using the electrification control system based on a set electrification method.

The cyclical alternate electrification includes that an electrified mining area is divided into M equal parts (M>2), and the electrification control system is used to carry out cyclical alternate electrification from 1 to M. For example, the electrified mining area can be divided into 2, 3, 4, . . . equal parts. Correspondingly, 2-cycle alternate electrification, 3-cycle alternate electrification, 4-cycle alternate electrification or 5-cycle alternate electrification are required to be performed.

Compared with the simultaneous electrification of all mining areas, the cyclical alternate electrification solution divides the electric mining into 2 equal parts, 3 equal parts, 4 equal parts, or 5 equal parts, and the electric power demand of electric mining, the construction cost of transformer, the complexity of electrode arrangement and the length of wire and cable are reduced in each cycle of electrification process. At the same time, in the process of cyclical alternate electrification, a leaching agent in an unelectrified area and rare earth ions in the soil can be fully exchanged, thus improving the rare earth leaching rate.

The division of the electrified area per cycle and the connection of positive and negative electrodes to the electrode are shown according to the formula of the present disclosure:
in an Nun (1<N<M) electrification cycle, all electrodes of an (M×n+N)ₜₕ (n=0, 1, 2, 3, . . . ) row are connected to a positive electrode of a power supply, and all electrodes of an (M×n+N+1)ₜₕ (n=0, 1, 2, 3, . . . ) row are connected to a negative electrode of the power supply.

As an example, in the 2_{nd} cycle of 3-cycle alternate electrification (i.e., the 2_{nd} of 3 electrifications), the electrification control system will connect the 2_{nd}, 5ₜₕ, 8ₜₕ, 11ₜₕ, 14ₜₕ, . . . , and (3n+2)ₜₕ rows of electrodes to a positive electrode of a power supply, and the 3_{rd}, 6ₜₕ, 9ₜₕ, 12ₜₕ, 15ₜₕ, . . . , and (3n+2+1)ₜₕ rows of electrodes to a negative electrode of the power supply.

As another example, in the 3_{rd} cycle of 4-cycle alternate electrification (i.e., the 3_{rd} of 4 electrifications), the electrification control system will connect the 3_{rd}, 7ₜₕ, 11ₜₕ, 15ₜₕ, 19ₜₕ, . . . , and (4n+3)ₜₕ rows of electrodes to a positive electrode of a power supply, and the 4ₜₕ, 8ₜₕ, 12ₜₕ, 16ₜₕ, 20ₜₕ, . . . , and (4n+3+1)ₜₕ rows of electrodes to a negative electrode of the power supply.

In the electrification solution of the present disclosure, each row of electrodes is connected to the positive electrode and the negative electrode of the power supply in turn, and an electrode switching phenomenon occurs, which on the one hand is conducive to eliminating polarization and reducing the accumulation of electric charge generated by a continuous electrification process, preventing the influence of the efficiency of electrified mining, and on the other hand, is capable of automatically neutralizing H′ and OH generated by electrolysis, preventing soil pollution.

However, the electrode reversal in the present disclosure is not an electrode swap between two sets of fixed electrodes traditionally, but cross-power electrode reversal, that is, a negative electrode of the last set of power supply becomes a positive electrode, a positive electrode of the next set of power supply becomes a negative electrode, and a new set of power supply is re-formed between the last set of power supply and the next set of power supply.

According to the electrification solution, the rare earth ions in any cycle always migrate towards the same direction without reversal of current direction and reverse migration of rare earth ions. If the positive electrode and the negative electrode are swapped between two electrodes of a fixed power supply during pulse electrification, the electrode polarization can be effectively relieved, but some ions diffuse backwards within the reverse electrification time, reducing the rare earth migration efficiency.

At the same time, the rare earth mining efficiency is improved and the power consumption is reduced by 20-80% compared with the continuous electrification of all areas.

### Example 1

The example provides a method for mining rare earth ore using a direct current, which was tested in Renju mining area, Meizhou City, Guangdong Province. The method for electrified mining of the rare earth ore includes the following steps.

(1) Liquid injection holes and electrodes were arranged: 16 rows and 11 columns of 176 liquid injection holes were evenly arranged in a test area of 15 m long and 10 m wide, the spacing around the liquid injection holes being 1 m, and a depth of the liquid injection hole being 24 m; a 12-m electrode was arranged in each liquid injection hole, and the depth range of the electrode was 12 m upward from the bottom of the liquid injection hole to cover the ore-rich layer; upper ends of the electrodes were connected to 13-m wires; and the electrodes of 11 columns in each row were connected to a control system after being parallel-connected.

(2) A leaching agent was injected: an ammonium sulfate solution with a mass fraction of 2.5% was injected into the liquid injection holes, and a total dosage of ammonium sulfate was 3 times of a total amount of rare earth ions.

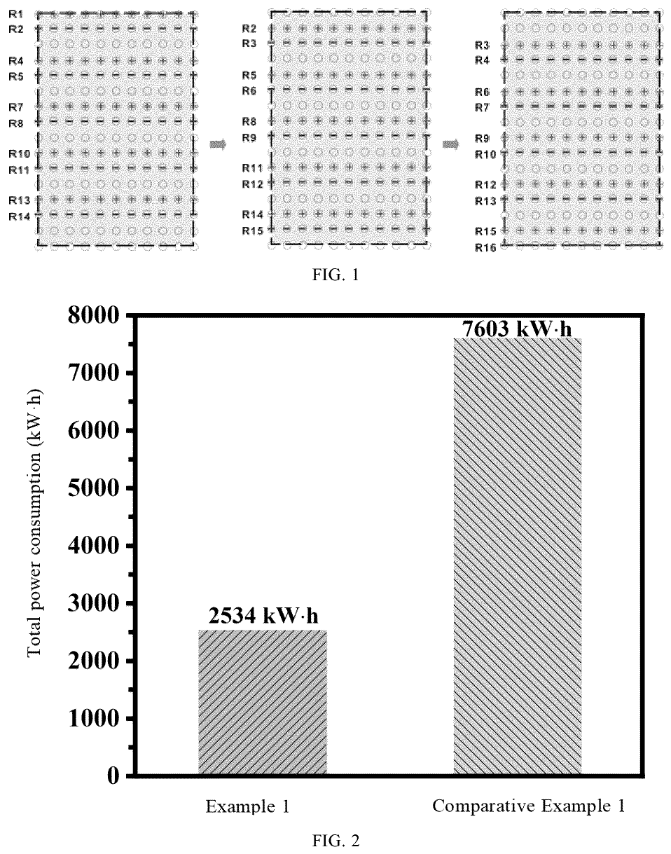

(3) Electrification was performed: 3-cycle alternate electrification method was used for electrification. FIG. 1 shows a schematic diagram of a 3-cycle alternate electrification solution; and Table 1 shows electrification of electrodes in the 1ₛₜ, 2_{nd} and 3_{rd} cycles of a 3-cycle alternate electrification process, with an electrification duration of 1 h per cycle, and a voltage gradient of 60 V/m.

TABLE 1

| | | | | | | | Computa- |
|---|---|---|---|---|---|---|---|
| Alternate | | | | | | | tional |
| cycle | Electrified electrode | | | | | | formula |
| 1 | R1R2 | R4R5 | R7R8 | R10R11 | R13R14 | . . . | (3n + 1, |
| | | | | | | | 3n + 2) |
| 2 | R2R3 | R5R6 | R8R9 | R11R12 | R14R15 | . . . | (3n + 2, |
| | | | | | | | 3n + 3) |
| 3 | R3R4 | R6R7 | R9R10 | R12R13 | R15R16 | . . . | (3n + 3, |
| | | | | | | | 3n + 4) |

(4) Solution was collected: a kilometer borehole was arranged at the bottom of the mining area to collect a rare earth mother solution by electrified mining.

A power demand of an electrified mining process was about 4 kW, 1.56 tons of rare earths were collected in 1 month, with a rare earth recovery rate of 94%, and a total power consumption of 2534 kw·h.

### Comparative Example 1

The comparative example provides a method for electrified mining of rare earth ore, which was tested in Renju mining area, Meizhou City, Guangdong Province. The difference from the method in Example 1 lies in step (3). In the comparative example, all electrodes were continuously electrified for 1 month in step (3) according to the mode of positive-negative . . . , and positive-negative.

In the comparative example, a power demand of an electrified mining process was about 11 kw, 0.21 tons of rare earths were collected in 1 month, with a rare earth recovery rate of 13%, and a total power consumption of 7603 kw·h.

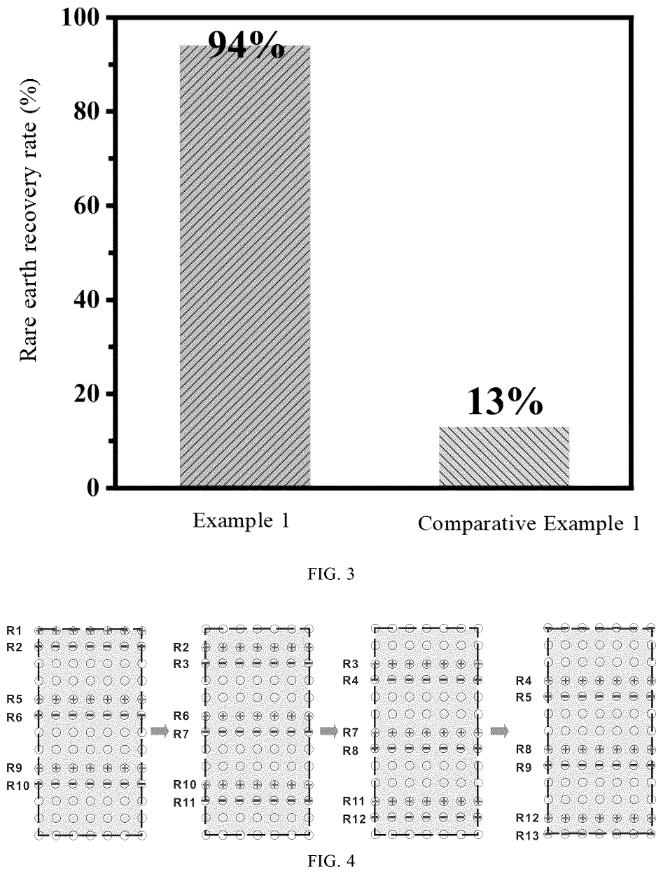

As shown in FIG. 2 and FIG. 3, it can be seen from Comparative Example 1 and Example 1 that the method provided in Example 1 has an 81% increase in rare earth recovery, a 67% reduction in power consumption, and a 64% reduction in power demand over Comparative Example 1. Due to the continuous electrification of all areas in Comparative Example 1, the strong polarization and electrolysis are produced in the long-time electrification process, and the positive-negative-positive electrode arrangement and electrification solution results in at least half of the rare earths having to overcome the gravity to migrate reversely to the negative electrode, reducing the rare earth extraction rate. In addition, the power consumption increases and the power demand therefore increases.

### Example 2

The example provides a method for electrified mining of rare earth ore, which was tested in Renju mining area, Meizhou City, Guangdong Province. The difference from the method in Example 1 lies in steps (1), (2) and (3). In the example, the steps of the method are as follows.

(1) Liquid injection holes and electrodes were arranged: 21 rows and 17 columns of 357 liquid injection holes were evenly arranged in a test area of 30 m long and 24 m wide, the spacing around the liquid injection holes being 1.5 m, and a depth of the liquid injection hole being 15 m; an 8-m electrode was arranged in each liquid injection hole, and a depth range of the electrode was 8 m upward from the bottom of the liquid injection hole to cover the ore-rich layer; upper ends of the electrodes were connected to 7-m wires; and the electrodes of 17 columns in each row were connected to a control system after being parallel-connected.

(2) A leaching agent was injected: an ammonium sulfate solution with a molar concentration of 0.2 M was injected into the liquid injection holes, and a total dosage of ammonium sulfate was 4 times of a total amount of rare earth ions.

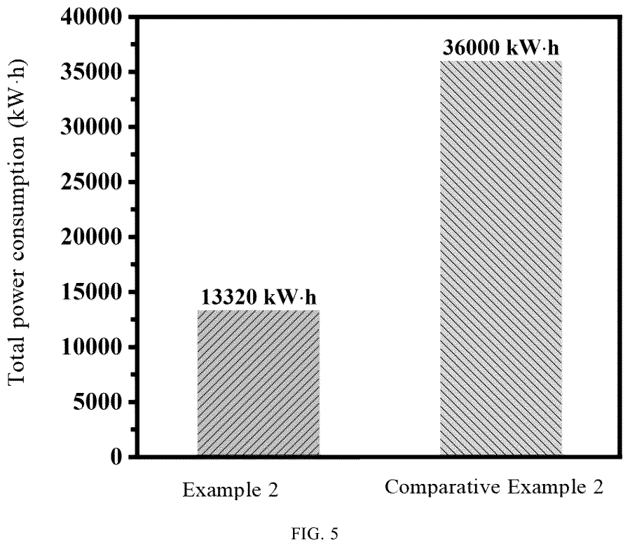

(3) Electrification was performed: a 4-cycle alternate electrification solution was used for electrification. FIG. 4 shows a schematic diagram of the 4-cycle alternate electrification solution; and Table 2 shows electrification of electrodes in the 1ₛₜ, 2_{nd}, 3_{rd} and 4ₜₕ cycles of a 4-cycle alternate electrification process, with an electrification duration of 2 h and a voltage gradient of 90 V/m per cycle.

TABLE 2

| | | | | | | | Computa- |
|---|---|---|---|---|---|---|---|
| Alternate | | | | | | | tional |
| cycle | Electrified electrode | | | | | | formula |
| 1 | R1R2 | R5R6 | R9R10 | R13R14 | R17R18 | . . . | (4n + 1, |
| | | | | | | | 4n + 2) |
| 2 | R2R3 | R6R7 | R10R11 | R14R15 | R18R19 | . . . | (4n + 2, |
| | | | | | | | 4n + 3) |
| 3 | R3R4 | R7R8 | R11R12 | R15R16 | R19R20 | . . . | (4n + 3, |
| | | | | | | | 4n + 4) |
| 4 | R4R5 | R8R9 | R12R13 | R16R17 | R20R21 | . . . | (4n + 4, |
| | | | | | | | 4n + 5) |

A power demand of an electrified mining process was about 6 kW, 3.71 tons of rare earths were collected in 2 months, with a rare earth recovery rate of 91%, and a total power consumption of 13320 kw·h.

### Comparative Example 1

The comparative example provides a method for electrified mining of rare earth ore, which was tested in Renju mining area, Meizhou City, Guangdong Province. The difference from the method in Example 2 lies in step (3). In the comparative example, in step (3), electrification was performed continuously on all electrodes for 2 months according to the mode of positive-negative . . . , and positive-negative.

In the comparative example, a power demand of an electrified mining process was about 25 kW, 1.57 tons of rare earths were collected in 2 months, with a rare earth recovery rate of 38%, and a total power consumption of 36000 kw·h.

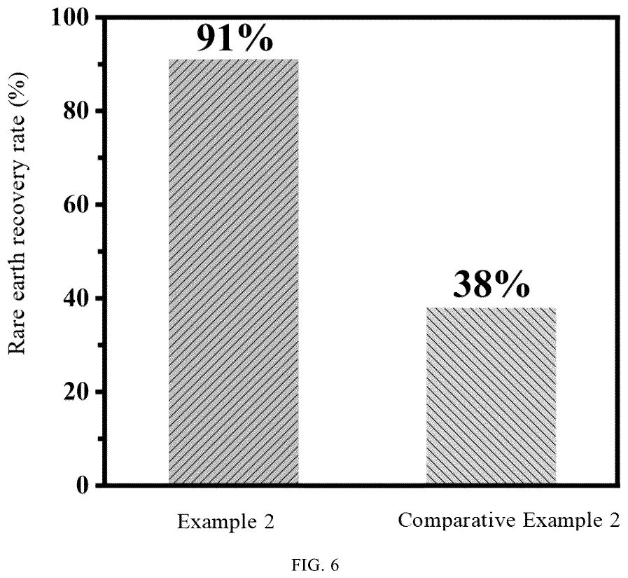

As shown in FIG. 5 and FIG. 6, it can be seen from Comparative Example 2 and Example 2 that the method provided in Example 2 provides a 53% increase in rare earth recovery, a 63% reduction in power consumption, and a 76% reduction in power demand over Comparative Example 2.

To sum up, it can be seen that in the method provided by the examples of the present disclosure, the cyclical alternate electrification solution can significantly increase the rare earth recovery rate and reduce the power consumption and power demand.

It is to be noted that the examples as described above are merely used for illustrating the technical solutions of the present disclosure, rather than limiting the present disclosure. Although the present disclosure is described in detail by reference to the foregoing examples, it is to be understood by those ordinary skilled in the art that the technical solution set forth in each example can still be modified or some technical features can be replaced equivalently, and those modifications or equivalent replacements cannot make the corresponding technical solution out of the spirit and scope of the technical solution of the present disclosure.

1. A method for mining rare earth ore using a direct current, comprising the following steps:
step 1: arranging at least 3 rows and at least 1 column of liquid injection holes in a mining area, arranging electrodes in the liquid injection holes, and connecting each row of the electrodes in parallel to an electrification control system; and
step 2: adding a leaching agent into the liquid injection holes, and applying a direct current between the electrodes using the electrification control system based on a set electrification method, wherein
the electrification method is cyclical alternate electrification,
the cyclical alternate electrification refers to that the mining area is divided into M equal parts, and the electrification control system is used to carry out cyclical alternate electrification from 1 to M, M>2, and M being a positive integer, and
in an Nth electrification cycle, all electrodes of an (M×n+N)ₜₕ (n=0, 1, 2, 3, . . . ) row are connected to a positive electrode of a power supply, and all electrodes of an (M×n+N+1)ₜₕ (n=0, 1, 2, 3, . . . ) row are connected to a negative electrode of the power supply, N≤M.

2. The method for mining rare earth ore using a direct current according to claim 1, wherein the number of cycles for the cyclical alternate electrification is at least greater than 2.

3. The method for mining rare earth ore using a direct current according to claim 1, wherein the number of rows of the liquid injection hole is determined by an area of the mining area, and spacing of the liquid injection holes of each row is 0.5-3 m; and
alternatively, the spacing of the liquid injection holes of each row is 1 m.

4. The method for mining rare earth ore using a direct current according to claim 1, wherein the number of columns of the liquid injection hole is determined by the area of the mining area, and spacing of the liquid injection holes of each column is 0.5-3 m; and
alternatively, the spacing of the liquid injection holes of each column is 1 m.

5. The method for mining rare earth ore using a direct current according to claim 1, wherein a depth of the liquid injection hole is determined by a thickness of a weathering crust; and
alternatively, the depth of the liquid injection hole is 5-50 m.

6. The method for mining rare earth ore using a direct current according to claim 1, wherein an arrangement depth of the electrode is determined by the depth of the liquid injection hole; and
alternatively, the arrangement depth of the electrode is 5-50 m.

7. The method for mining rare earth ore using a direct current according to claim 1, wherein the leaching agent comprises at least one of ammonium sulfate, ammonium chloride, ammonium acetate, ammonium citrate, calcium chloride, magnesium sulphate, potassium sulfate, sodium sulfate, potassium chloride, and sodium chloride.

8. The method for mining rare earth ore using a direct current according to claim 1, wherein a voltage is applied between the positive electrode and the negative electrode to cause a voltage gradient in an ore body to be 10-200 V/m.

9. The method for mining rare earth ore using a direct current according to claim 1, wherein a duration of electrification lasts for 0.1-24 h per cycle.

10. A system for mining rare earth ore using a direct current, comprising:
liquid injection holes, at least 3 rows and at least 1 column of liquid injection holes being arranged in a mining area;
electrodes, the electrodes being arranged in the liquid injection holes, and each row of electrodes being connected in parallel to an electrification control system;
a leaching agent, the leaching agent being added into the liquid injection holes; and
the electrification control system, the electrification control system being configured to divide the mining area into M equal parts and electrify the electrodes using a cyclical alternate electrification method from 1 to M, M>2, and M being a positive integer, wherein
in an Nₜₕ electrification cycle, all electrodes of an (M×n+N)ₜₕ (n=0, 1, 2, 3, . . . ) row are connected to a positive electrode of a power supply, and all electrodes of an (M×n+N+1)ₜₕ (n=0, 1, 2, 3, . . . ) row are connected to a negative electrode of the power supply, N≤M, and
the number of cycles for electrification is at least greater than 2.
